(19) United States
(12) Patent Application Publication
(10) Pub. No.: US 2022/0066965 A1
(43) Pub. Date: Mar. 3, 2022

(54) METHOD, SYSTEM AND DEVICE FOR MODIFYING AN OPTION OF A BASIC INPUT OUTPUT SYSTEM

(71) Applicants: Inventec (Pudong) Technology Corporation, Shanghai (CN); INVENTEC CORPORATION, Taipei (TW)

(72) Inventors: Xianle Tan, Shanghai (CN); Qi LIU, Shanghai (CN); Zhongying QU, Shanghai (CN)

(73) Assignees: Inventec (Pudong) Technology Corporation, Shanghai (CN); INVENTEC CORPORATION, Taipei (TW)

(21) Appl. No.: 17/029,063

(22) Filed: Sep. 23, 2020

(30) Foreign Application Priority Data
Aug. 27, 2020 (CN) 2020108793238

(51) Int. Cl. G06F 13/20; G06F 21/57

(52) U.S. Cl. CPC G06F 13/20; G06F 2221/034; G06F 21/572

(57) ABSTRACT

The present disclosure provides a method, system and device for modifying an option of a basic input output system, which is applied to a basic input output system. The method includes the following: when starting up, reading the setting value of each option of the basic input output system from a baseboard management controller; comparing the current value of each option in the basic input output system with the corresponding setting value, when the current value is different from the setting value, modifying the current value to the setting value. In the method, system and device for modifying an option of a basic input output system provided by the present disclosure, the options of the basic input output system are saved and modified through a baseboard management controller, which ensures safe and effective settings of the basic input output system options.

### CROSS REFERENCE TO RELATED APPLICATION

This application claims the benefits of priority to Chinese Patent Application No. CN 2020108793238, entitled “Method, System and Device for Modifying an Option of a Basic Input Output System”, filed with CNIPA on Aug. 27, 2020, the contents of which are incorporated herein by reference in its entirety.

### BACKGROUND

### Field of Disclosure

The present disclosure relates to the technical field of basic input output systems (BIOS), in particular, to a method, system and device for modifying an option of a basic input output system.

### Description of Related Arts

Traditional BIOS saves and modifies the settings of the BIOS options through a field replace unit (FRU) of a baseboard management controller (BMC). However, the above-described design has the following disadvantages:

(1) It cannot save and modify all BIOS options out-of-band;

(2) When the BIOS adds or subtracts certain options, the design of FRU cannot match the architecture of the new BIOS options;

(3) The FRU space offset values of the BMC corresponds to the BIOS options one-to-one. If the FRU space is mistakenly brushed, the BIOS will write the wrong value into the register, thus causing some security risks.

### SUMMARY

The present disclosure provides a method, system and device for modifying an option of a basic input output system. The options of the basic input output system are saved and modified through a baseboard management controller, which ensures safe and effective settings of the basic input output system options.

The present disclosure provides a method for modifying an option of a basic input output system, applied to a basic input output system, and including: when starting up, reading the setting value of each option of the basic input output system from a baseboard management controller; comparing the current value of each option in the basic input output system with the corresponding setting value, when the current value is different from the setting value, modifying the current value to the setting value.

In an embodiment of the present disclosure, the method further includes: after a normal startup, storing the setting value of each option of the basic input output system in the baseboard management controller.

In an embodiment of the present disclosure, the setting value of each option of the basic input output system is read from the baseboard management controller based on a Redfish interface.

In an embodiment of the present disclosure, the setting value of each option is stored in the baseboard management controller through a jason file.

In an embodiment of the present disclosure, the jason file is stored in a jason buffer area of the baseboard management controller.

Correspondingly, the present disclosure provides a system for modifying an option of the basic input output system, which is applied to the basic input output system, and includes a read module and an update module;

the read module reads the setting value of each option of the basic input output system from the baseboard management controller at startup;

The update module compares the current value of each option in the basic input output system with the corresponding setting value, and modifies the current value to the setting value when the current value is different from the setting value.

The present disclosure provides a device for modifying an option of the basic input output system, including the system for modifying an option of the basic input output system as described above and a baseboard management controller;

the baseboard management controller stores a setting value of an option of the basic input output system;

In an embodiment of the present disclosure, the baseboard management controller further modifies, according to a user instruction, the setting value of each option of the basic input output system.

As described above, the method, system and device for modifying an option of a basic input output system have the following beneficial effects:

(1) The options of the basic input output system are saved and modified through a baseboard management controller, which ensures safe and effective settings of the basic input output system options.

(2) All BIOS options saved in the BMC can be modified out-of-band;

(3) Since the matching is performed according to the names of the BIOS options, it is ensured that the BIOS option structure is still valid after a change, and the written BIOS options are matched one by one without security risks.

### BRIEF DESCRIPTION OF THE DRAWINGS

FIG. 1 shows a flow chart of a method for modifying an option of a basic input output system according to an embodiment of the present disclosure.

FIG. 2 shows a schematic diagram of a system for modifying an option of a basic input output system according to an embodiment of the present disclosure.

FIG. 3 shows a schematic diagram of a device for modifying an option of a basic input output system according to an embodiment of the present disclosure.

### DESCRIPTION OF REFERENCE NUMERALS

21 Read module
22 Update module
31 System for modifying an option of a basic input output system
32 Baseboard management controller

### DETAILED DESCRIPTION OF THE PREFERRED EMBODIMENTS

The embodiments of the present disclosure will be described below. Those skilled in the art can easily understand other advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complex.

In the method, system and device for modifying an option of a basic input output system according to the present disclosure, the baseboard management controller and the basic input output system communicate through Redfish, and the options of the basic input output system are saved and modified through the baseboard management controller. After the option in the basic input output system is modified, the next time the basic input output system is started-up, the modified BIOS option will be imported from the baseboard management controller and then the system is restarted, the modified BIOS option takes effect, thereby ensuring the safe and effective setting of the basic input output system options.

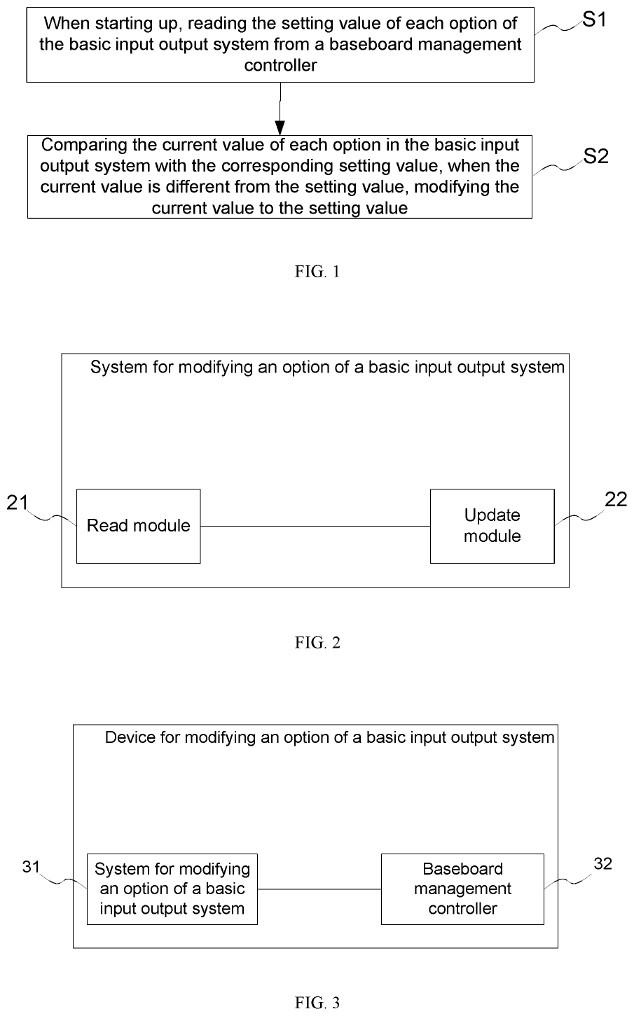

As shown in FIG. 1, in an embodiment, the method for modifying an option of a basic input output system is applied to a basic input output system, and includes the following:

S1: when starting up, reading the setting value of each option of the basic input output system from a baseboard management controller.

Specifically, after a normal start-up of the basic input output system, the setting value of each option of the basic input output system is stored in the baseboard management controller based on the Redfish interface. In an embodiment of the present disclosure, the setting value of each option is stored in the baseboard management controller through a jason file. The jason file is stored in a jason buffer area of the baseboard management controller. The basic input output system obtains the jason file stored in the Jason buffer in the baseboard management controller through a Rest Over IPMI Protocol.

At the same time, the user may modify the setting values of the options stored in the baseboard management controller. In a next start-up, the setting value of each option of the basic input output system is read from the baseboard management controller based on the Redfish interface. That is to say, when started up again, the setting value of each option in the baseboard management controller and the current value of each option in the basic input output system may be the same or different.

S2, comparing the current value of each option in the basic input output system with the corresponding setting value, when the current value is different from the setting value, modifying the current value to the setting value.

Specifically, the basic input output system compares the current values and the setting values of the options. First, obtaining a same option name, and then comparing a current value and a setting value corresponding to the option name. If the current value is consistent with the setting value, it means that the option value of the basic input output system is not modified, and the option value in the basic input output system is directly used for a start-up. If the current value and the setting value are inconsistent, it means that the option value of the basic input output system has been modified by the baseboard management controller. Therefore, the current value of the basic input output system option is modified to the corresponding setting value in the baseboard management controller before starting up, so as to ensure the stability and reliability of the system.

As shown in FIG. 2, in an embodiment, the system for modifying an option of a basic input output system is applied to a basic input output system, and includes a read module 21 and an update module 22.

The read module 21 reads the setting value of each option of the basic input output system from the baseboard management controller at startup.

Specifically, after a normal start-up of the basic input output system, the setting value of each option of the basic input output system is stored in the baseboard management controller based on a Redfish interface. In an embodiment of the present disclosure, the setting value of each option is stored in the baseboard management controller through a jason file. The jason file is stored in a jason buffer area of the baseboard management controller. The basic input output system obtains the jason file stored in the Jason buffer in the baseboard management controller through a Rest Over IPMI Protocol.

At the same time, the user may modify the setting value of each option stored in the baseboard management controller. In a next start-up, the setting value of each option of the basic input output system is read from the baseboard management controller based on the Redfish interface. That is to say, when started up again, the setting value of each option in the baseboard management controller and the current value of each option in the basic input output system may be the same or different.

The update module 22 is connected with the read module 21. The update module 22 compares the current value of each option in the basic input output system with the corresponding setting value, and modifies the current value to the setting value when the current value is different from the setting value.

Specifically, the basic input output system compares the current values and the setting values of the options. First, a same option name is obtained, and then a current value and a setting value corresponding to the option name are compared. If the current value is consistent with the setting value, it means that the option value of the basic input output system is not modified, and the option value in the basic input output system is directly used for a start-up. If the current value and the setting value are inconsistent, it means that the option value of the basic input output system has been modified by the baseboard management controller. Therefore, the current value of the basic input output system option is modified to the corresponding setting value in the baseboard management controller before starting up, so as to ensure the stability and reliability of the system.

It should be noted that the division of each module of the above apparatus is only a division of logical functions. In actual implementation, the modules may be integrated into one physical entity in whole or in part, or may be physically separated. These modules may all be implemented in the form of processing component calling by software. They may also be implemented entirely in hardware. It is also possible that some modules are implemented in the form of processing component calling by software, and some modules are implemented in the form of hardware. For example, the x module may be a separate processing element, or may be integrated into a chip of the above-mentioned apparatus, or may be stored in the memory of the above apparatus in the form of program code. The function of the above x module is called and executed by one of the processing elements of the above apparatus. The implementation of other modules is similar. In addition, all or part of these modules may be integrated or implemented independently. The processing elements described herein may be an integrated circuit with signal processing capabilities. In the implementation process, each operation of the above method or each of the above modules may be completed by an integrated logic circuit of hardware in the processor element or an instruction in a form of software.

For example, the above modules may be one or more integrated circuits configured to implement the above method, such as one or more Application Specific Integrated Circuits (ASICs), or one or more Digital Signal Processors (DSPs), or one or more Field Programmable Gate Arrays (FPGAs). As another example, when one of the above modules is implemented in the form of calling program codes of a processing component, the processing component may be a general processor, such as a Central Processing Unit (CPU) or other processors that may call program codes. As another example, these modules may be integrated and implemented in the form of a system-on-a-chip (SOC).

As shown in FIG. 3, in an embodiment, the present disclosure provides a device for modifying an option of the basic input output system, including the system for modifying an option of the basic input output system 31 as described above and a baseboard management controller 32.

The baseboard management controller 32 is communicatively connected with the system for modifying an option of the basic input output system 31 through a Redfish interface, so as to store the setting value of each option of the basic input output system, to facilitate the reading of the setting value when the basic input output system is started up.

At the same time, the baseboard management controller 32 further modifies, according to a user instruction, the setting value of each option of the basic input output system, thereby realizing the off-chip modification of the option value of the basic input output system and increasing flexibility and usability of the system.

In summary, the present disclosure provides a method, system and device for modifying an option of a basic input output system. The options of the basic input output system are saved and modified through a baseboard management controller, which ensures safe and effective settings of the basic input output system options. All BIOS options saved in the BMC can be modified out-of-band. Since the matching is performed according to the names of the BIOS options, it is ensured that the BIOS option structure is still valid after a change, and the written BIOS options are matched one by one without security risks. Therefore, the present disclosure effectively overcomes various shortcomings in traditional technology and has high industrial utilization value.

The above-mentioned embodiments are merely illustrative of the principle and effects of the present disclosure instead of limiting the present disclosure. Modifications or variations of the above-described embodiments may be made by those skilled in the art without departing from the spirit and scope of the disclosure. Therefore, all equivalent modifications or changes made by those who have common knowledge in the art without departing from the spirit and technical concept disclosed by the present disclosure shall be still covered by the claims of the present disclosure.

What is claimed is:

1. A method for modifying an option of a basic input output system, which is applied to a basic input output system, and comprises the following:
when starting up, reading a setting value of each option of the basic input output system from a baseboard management controller;
comparing a current value of each option in the basic input output system with the corresponding setting value, when the current value is different from the setting value, modifying the current value to the setting value.

2. The method for modifying an option of a basic input output system according to claim 1, further comprising: after a normal startup, storing the setting value of each option of the basic input output system in the baseboard management controller.

3. The method for modifying an option of a basic input output system according to claim 1, further comprising: reading, based on a Redfish interface, the setting value of each option of the basic input output system from the baseboard management controller.

4. The method for modifying an option of a basic input output system according to claim 1, further comprising: storing, via a jason file, the setting value of each option in the baseboard management controller.

5. The method for modifying an option of a basic input output system according to claim 4, wherein the jason file is stored in a jason buffer area of the baseboard management controller.

6. A system for modifying an option of the basic input output system, which is applied to a basic input output system, comprising a read module and an update module;
the read module reads a setting value of each option of the basic input output system from a baseboard management controller at startup;
the update module compares a current value of each option in the basic input output system with a corresponding setting value, and modifies the current value to the setting value when the current value is different from the setting value.

7. A device for modifying an option of the basic input output system, comprising the system for modifying an option of the basic input output system as described in claim 6 and a baseboard management controller;
the baseboard management controller stores a setting value of each option of the basic input output system.

8. The device for modifying an option of a basic input output system according to claim 7, wherein the baseboard management controller further modifies, according to a user instruction, the setting value of each option of the basic input output system.
